(19) United States
(12) Patent Application Publication
(10) Pub. No.: US 2016/0116669 A1
(43) Pub. Date: Apr. 28, 2016

(54) PLANAR ILLUMINATION DEVICE, LIQUID CRYSTAL DISPLAY APPARATUS, AND METHOD OF ASSEMBLING THE SAME

(71) Applicant: MINEBEA CO., LTD, Kitasaku-gun (JP)

(72) Inventor: Makoto FURUTA, Fukuroi-shi (JP)

(73) Assignee: MINEBEA CO., LTD, Kitasaku-gun (JP)

(21) Appl. No.: 14/884,164

(22) Filed: Oct. 15, 2015

(30) Foreign Application Priority Data
Oct. 23, 2014 (JP) 2014-216444

(51) Int. Cl. F21V 8/00; G02F 1/1335

(52) U.S. Cl. CPC G02B 6/0091; G02F 1/133512

(57) ABSTRACT

A planar illumination device includes: a light guide plate including a pair of principal surfaces opposed to each other, one of the principal surfaces serving as a light emitting surface; a light source disposed to face a light incident surface of the light guide plate; an optical sheet disposed on the light emitting surface of the light guide plate; and a frame that houses therein the light guide plate. The frame includes a bottom portion formed of a sheet metal and a pair of resin portions facing the light incident surface of the light guide plate and an end face of the light guide plate opposite to the light incident surface, respectively.

### CROSS-REFERENCE TO RELATED APPLICATIONS

The present application claims priority to and incorporates by reference the entire contents of Japanese Patent Application No. 2014-216444 filed in Japan on Oct. 23, 2014.

### BACKGROUND OF THE INVENTION

1. Field of the Invention

The present invention relates to a planar illumination device, a liquid crystal display apparatus including the planar illumination device, and a method of assembling the same.

2. Description of the Related Art

Today, liquid crystal display apparatuses are commonly used as display devices for personal computers, cellular phones, and other electronic apparatuses. Because liquid crystal is not a spontaneous light emitting display element, a planar illumination device as an illumination means is widely used in combination with the liquid crystal display apparatus.

FIG. 5B illustrates a schematic configuration of a liquid crystal display apparatus 100 that includes such a planar illumination device. The liquid crystal display apparatus 100 includes a plurality of plate (or sheet) members including a liquid crystal display panel (LCD) 110, a light guide plate 12, a reflection sheet 118, and an optical sheet 18. More specifically, the light guide plate 12 formed of synthetic resin is disposed on a back surface side of the LCD 110. The light guide plate 12 is rectangular in a plan view and has a pair of principal surfaces that are opposed to each other. One of the principal surfaces (on a front surface of the light guide plate 12) serves as a light emitting surface. The reflection sheet 118 is disposed on a back surface of the light guide plate 12. The optical sheet 18 includes a plurality of layers (three layers in the example illustrated in FIG. 5B) disposed between the LCD 110 and the light guide plate 12. In a known configuration, these elements are housed, together with, for example, a white LED disposed to face a light incident surface of the light guide plate 12, inside a closed-bottom framework-shaped frame 124 (see FIGS. 6A and 6B) formed of synthetic resin, to thereby constitute the integrated liquid crystal display apparatus 100.

Hitherto, to precisely position the optical sheet 18 in the liquid crystal display apparatus 100, the optical sheet 18 has a tab 180a formed on an end side thereof as illustrated in FIG. 6A. The frame 124 has a recess 124c formed at a corresponding position therein to receive the tab 180a in a fitted manner. The optical sheet 18 is thus positioned correctly with respect to the frame 124 in directions of arrows A and B that are orthogonal to each other as illustrated in FIG. 6A (see, for example, Japanese Laid-open Patent Publication Nos. 2009-265237 and 2006-154320).

As described above, the liquid crystal display apparatus 100 has a structure in which its necessary elements are integrally held in place to achieve required strength by the frame 124 that is disposed so as to surround the LCD 110 in a framework manner. A need exists at all times for a narrower framework of the liquid crystal display apparatus 100 in terms not only of functionality for further reduction in size of the liquid crystal display apparatus 100, but also of design performance. Reducing the thickness of the frame 124 (thickness in the direction of the arrow B in FIG. 6A) in order to achieve a narrower framework makes it difficult to form the recess 124c in which to receive the tab 180a of the optical sheet 18. The reduction in the thickness of the frame 124 may further contribute to insufficient positioning of the optical sheet 18, hindering satisfaction of the need for a narrower framework of, the liquid crystal display apparatus 100.

A structure has been developed that achieves positioning of the optical sheet 18 with respect to the frame 124 without the use of the tab 180a and the recess 124c, to thereby enable a narrower framework through reduction in the thickness of the frame 124. Another known structure replaces the frame 124 with a metal frame (see, for example, Japanese Laid-open Patent Publication No. 2013-171723).

The reduction in the thickness of the framework of the resin frame leads to reduction in strength of the resin frame. From a productivity standpoint, resin frames are typically manufactured by injection molding; however, narrowing the frame width has its own limit, because it provides a hindrance to reliably filling a cavity in an injection mold with molten resin. In contrast, use of a metal frame allows required strength to be easily achieved and a bending operation involved with the metal frame facilitates forming of a shape that is advantageous in making a narrower framework.

With the metal frame, however, when the light guide plate is brought into contact with the metal frame in order to position the light guide plate with respect to the metal frame during an assembly of the light guide plate, fine resin particles (contaminants) are produced from the light guide plate formed of synthetic resin, reducing uniformity of illumination light and otherwise impairing reliability as the planar illumination device. The use of the metal frame further requires a separate measure for providing proper insulation between the metal frame and a wiring board of a point-like light source.

### SUMMARY OF THE INVENTION

It is an object of the present invention to at least partially solve the problems in the conventional technology.

A planar illumination device may include: a light guide plate including a pair of principal surfaces opposed to each other, one of the principal surfaces serving as a light emitting surface; a light source disposed to face a light incident surface of the light guide plate; an optical sheet disposed on the light emitting surface of the light guide plate; and a frame that houses therein the light guide plate. The frame includes a bottom portion formed of a sheet metal and a pair of resin portions facing the light incident surface of the light guide plate and an end face of the light guide plate opposite to the light incident surface, respectively.

Moreover, a liquid crystal display apparatus may include: a planar illumination device including: a light guide plate including a pair of principal surfaces opposed to each other, one of the principal surfaces serving as a light emitting surface; a light source disposed to face a light incident surface of the light guide plate; an optical sheet disposed on the light emitting surface of the light guide plate; and a frame that houses therein the light guide plate, wherein the frame includes a bottom portion formed of a sheet metal and a resin portion facing the light incident surface of the light guide plate, and the frame includes first side walls that extend upward continuously from the bottom portion of the frame along two facing sides of the bottom portion, each of the sides connecting an end of a side of the bottom portion closer to the light incident surface of the light guide plate and an end of a side of the bottom portion farther from the light incident surface; a liquid crystal panel stacked on a side of the light emitting surface of the light guide plate; and a light shielding sheet configured to define an effective area of the light emitting surface of the light guide plate, wherein the light shielding sheet includes adhesive layers formed on both a first surface that faces the liquid crystal panel and a second surface that faces the light guide plate, and the first surface of the light shielding sheet is affixed to a portion of a surface of the liquid crystal panel facing the planar illumination device before the liquid crystal panel is stacked on the planar illumination device, the portion being opposed to end faces of the first side walls of the frame of the planar illumination device.

Moreover, a method of assembling a liquid crystal display apparatus may include: providing the above-described planar illumination device and a liquid crystal panel disposed closer to the light emitting surface of the light guide plate; affixing a light shielding sheet configured to define an effective area of the light emitting surface of the light guide plate to a portion of a surface of the liquid crystal panel facing the planar illumination device, the portion being opposed to end faces of the first side walls of the frame of the planar illumination device; and fixing the liquid crystal panel and the planar illumination device with the light shielding sheet.

Moreover, a planar illumination device may include: a light guide plate including a pair of principal surfaces opposed to each other, one of the principal surfaces serving as a light emitting surface; a light source disposed to face a light incident surface of the light guide plate; an optical sheet disposed on a side of the light emitting surface of the light guide plate; and a frame that houses therein the light guide plate, wherein the frame includes a bottom portion formed of a sheet metal and a resin portion that faces the light incident surface of the light guide plate.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIGS. 1A, 1B, and 1C are views illustrating a planar illumination device according to an embodiment of the present invention, FIG. 1A being a plan view, FIG. 1B being an enlarged cross-sectional view taken along line A-A in FIG. 1A, and FIG. 1C being an enlarged cross-sectional view taken along line B-B in FIG. 1A;

FIG. 2 is an enlarged view illustrating essential parts of the planar illumination device illustrated in FIG. 1A from which an optical sheet and some of other elements are omitted;

FIG. 3 is a partial enlarged view of FIG. 1A;

FIGS. 4A and 4B are partial enlarged views of FIG. 1C, exemplifying modes of a light shielding sheet;

FIGS. 5A and 5B are views exemplifying an assembly procedure for the planar illumination device illustrated in FIGS. 1A, 1B, and 1C and a liquid crystal panel; and

FIG. 6A is a partial view illustrating a known planar illumination device having a tab and FIG. 6B is a partial view illustrating a known planar illumination device including an optical sheet having no tabs.

### DETAILED DESCRIPTION OF THE PREFERRED EMBODIMENTS

The following describes an embodiment of the present invention with reference to the accompanying drawings. In this following, the components identical to those in the related art or the corresponding components found in the related art are denoted by the same reference numerals and descriptions therefor will not be duplicated. Directional expressions of “upper” and “lower” in the following description are given with reference to a vertical direction when the planar illumination device being described is placed in a horizontally flat position. The term “inside” as used to describe each of different elements of the planar illumination device refers to a side facing the central portion when the planar illumination device being described is placed in the horizontally flat position, so that the term “outside” refers to a side opposite to “inside”.

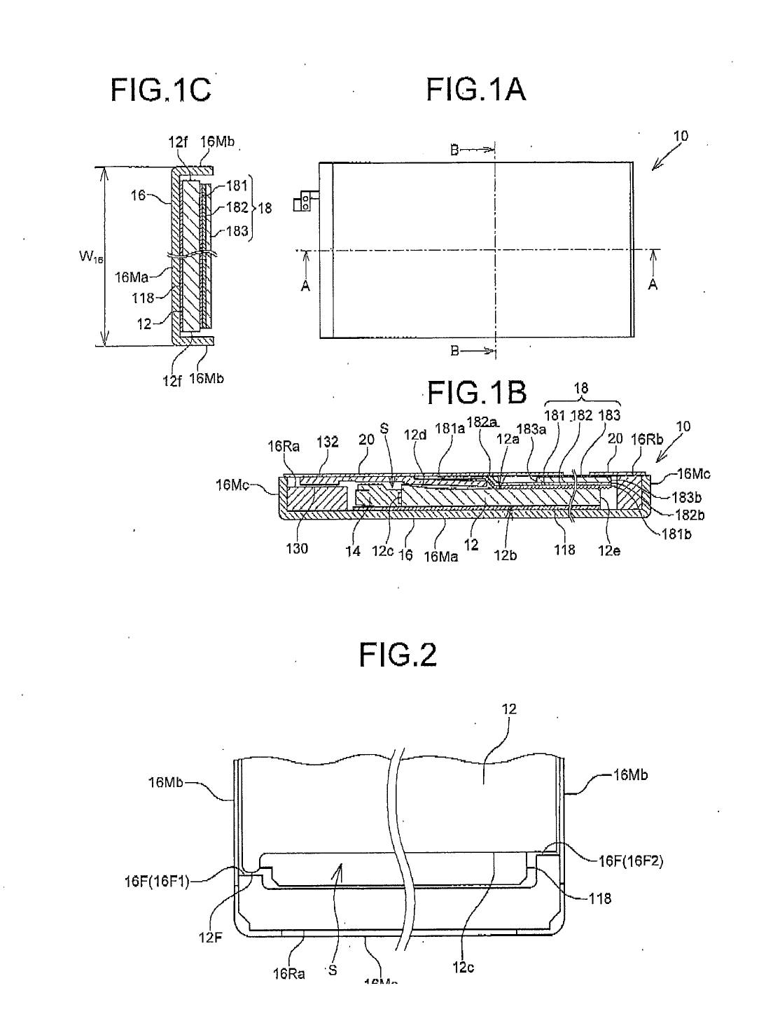

FIGS. 1A, 1B, and 1C illustrate this planar illumination device 10. The planar illumination device 10 includes a light guide plate 12, a plurality of optical sheets 18, a light shielding sheet 20, an LED as a light source 14 (a point-like light source), and a frame 16. More specifically, the light guide plate 12 has a pair of principal surfaces 12a and 12b that are opposed to each other. The principal surface 12a serves as a light emitting surface. The optical sheets 18 are stacked one on top of another on the light emitting surface 12a. The light shielding sheet 20 defines an effective area of the light emitting surface 12a. The light source 14 is disposed to face a light incident surface 12c of the light guide plate 12. The frame 16 houses therein the foregoing elements.

A reflection sheet 118 is fixed to a side of the principal surface 12b opposed to the light emitting surface 12a of the light guide plate 12.

The light guide plate 12 has an inclined surface 12d formed on the light emitting surface 12a, extending over a range of a predetermined width from the light incident surface 12c toward a central portion of the light guide plate 12. The inclined surface 12d decreases the thickness between the pair of principal surfaces opposed to each other toward the central portion of the light guide plate 12. The thickness between the principal surfaces remains constant over a range toward the central portion beyond the inclined surface 12d.

The frame 16 includes a bottom portion 16Ma and a pair of resin portions 16Ra and 16Rb. Specifically, the bottom portion 16Ma is an aluminum alloy or stainless steel sheet stock formed into a desired shape. The resin portions 16Ra and 16Rb face the light incident surface 12c of the light guide plate 12 and an end face 12e opposed to the light incident surface 12c, respectively. The bottom portion 16Ma has a thickness of, for example, 0.1 mm to 0.2 mm. The resin portions 16Ra and 16Rb are each, for example, a bar member formed of white resin. The resin portions 16Ra and 16Rb thus formed efficiently reflect light that leaks from the light incident surface 12c and the end face 12e of the light guide plate 12 opposed to the resin portions 16Ra and 16Rb, respectively, onto the light guide plate 12, thereby contributing to enhanced efficiency of light emitting from the principal surface 12a of the light guide plate 12.

Additionally, in the example illustrated in FIGS. 1A to 1C, the frame 16 has a first side wall 16Mb (see FIG. 1C) that extends upward continuously from the bottom portion 16Ma of the frame 16 along each of two facing sides of the bottom portion 16Ma, the sides connecting an end of a side of the bottom portion 16Ma closer to the light incident surface 12c of the light guide plate and an end of a side of the bottom portion 16Ma farther from the light incident surface 12c. In addition, the frame 16 has a second side wall 16Mc (see FIG. 1B) that extends upward continuously from the bottom portion 16Ma of the frame 16 along a side closer to the light incident surface 12c of the light guide plate 12 and a side farther from the light incident surface 12c. The first side walls 16Mb and the second side walls 16Mc have abutment portions that become continuous for drawing and separate for stamping and bending. The first side walls 16Mb and the second side walls 16Mc each have a thickness identical to that of the bottom portion 16Ma (e.g., 0.1 mm to 0.2 mm).

The resin portions 16Ra and 16Rb, the bottom portion 16Ma, the first side walls 16Mb, and the second side walls 16Mc of the frame 16 are integrated with each other by insert molding.

As illustrated in FIG. 1C, a pair of side end faces 12f of the light guide plate 12, each of the side end faces 12f connecting corresponding ends of the light incident surface 12c and the end face 12e opposed to the light incident surface 12c of the light guide plate 12, are spaced apart from the first side wall 16Mb. Similarly, as illustrated in FIG. 1B, the end face 12e of the light guide plate 12 is spaced apart from the resin portion 16Rb. Meanwhile, the light incident surface 12c of the light guide plate 12 is in contact with the light source-14 and the light source 14 is spaced apart from the resin portion 16Ra.

As illustrated in FIG. 2, the resin portion 16Ra of the frame 16 disposed so as to face the light incident surface 12c of the light guide plate 12 has first protrusions 16F (16F1 and 16F2) that protrude toward the light incident surface 12c of the light guide plate 12. Meanwhile, the light incident surface 12c of the light guide plate 12 has a second protrusion 12F that protrudes toward the resin portion 16Ra of the frame 16 disposed so as to face the light incident surface 12c. In the example illustrated in FIG. 2, the first protrusion 16F1 and the second protrusion 12F are located so as to be in abutment with each other. The light guide plate 12 has no second protrusion to face the first protrusion 16F2. The first protrusions 16F and the second protrusion 12F disposed as described above form a space S in a plan view between the light incident surface 12c of the light guide plate 12 and the resin portion 16Ra of the frame 16. The space S provides a spade for disposing the light source 14 (see FIG. 1B). The first protrusions 16F and the second protrusion 12F are required only to have shapes that allow the space S to be formed as necessary.

In the embodiment, the optical sheets 18 include a first sheet 181, a second sheet 182, and a third sheet 183. Specifically, the first sheet 181 is stacked on the light emitting surface 12a of the light guide plate 12. The second sheet 182 is stacked on the first sheet 181. The third sheet 183 is stacked on the second sheet 182. Exemplarily, the first sheet 181 is a diffusion sheet, the second sheet 182 is a lower prism sheet, and the third sheet 183 is an upper prism sheet. The first, second, and third sheets 181, 182, and 183 have end edge portions 181b, 182b, and 183b (see FIG. 1B), respectively, closer to the end face 12e opposed to the light incident surface 12c. The first, second, and third sheets 181, 182, and 183 further have end edge portions 181a, 182a, and 183a, respectively, closer to the light incident surface 12c of the light guide plate 12. The first, second, and third sheets 181, 182, and 183 are formed such that the end edge portions 181b, 182b, and 183b are aligned in a plan view and that the end edge portions 181a, 182a, and 183a are spaced further apart from the light incident surface 12c of the light guide plate 12 in the order of stacking on the light emitting surface 12a of the light guide plate 12.

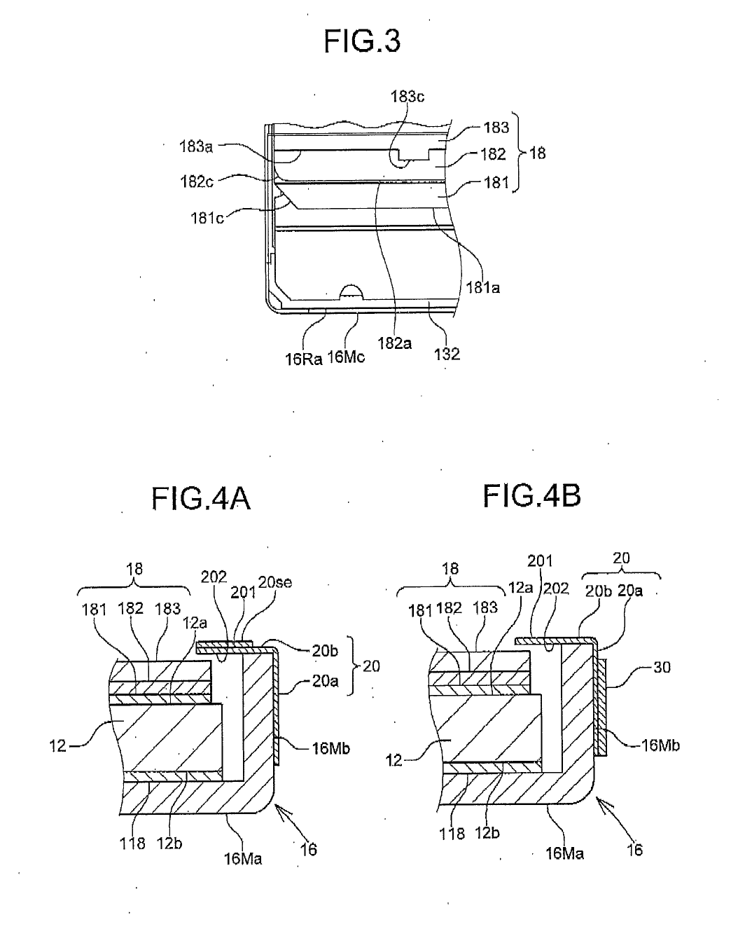

As exemplified in FIG. 3, for example, the first sheet 181 has a chamfered surface 181c formed at an asymmetrical position in a plan view on the end edge portion 181a closer to the light incident surface of the light guide plate, the second sheet 182 has a corner radius 182c formed at an asymmetrical position in the plan view on the end edge portion 182a closer to the light incident surface of the light guide plate, and the third sheet 183 has a tab 183c formed at an asymmetrical position in the plan view on the end edge portion 183a closer to the light incident surface of the light guide plate. These arrangements allow identification of each of the optical sheets and determination of the front and back sides of the optical sheet.

The “effective area” of the light emitting surface 12a defined by the light shielding sheet 20 excludes a “non-effective area” that unavoidably occurs near an end edge portion of the light emitting surface 12a of the light guide plate 12 due to degraded uniformity of emitted light caused by, for example, reflection of light on the side end faces of the light guide plate 12. The planar illumination device of the embodiment maximizes an effective use of the emitted light from the effective area using the light shielding sheet 20 that covers the non-effective area in a plan view of the light emitting surface 12a of the light guide plate 12.

In the example illustrated in FIGS. 1A, 1B, and 1C, the light shielding sheet 20 extends to cover an area from the second side wall 16Mc (see FIG. 1B) closer to the light incident surface 12c of the light guide plate 12 to an area near the end edge portion 183a closer to the light incident surface 12c of the light guide plate 12 of the optical sheet 183 in the uppermost layer. Similarly, the light shielding sheet 20 extends to cover an area from the second side wall 16Mc (see FIG. 1B) closer to the end face 12e opposed to the light incident surface 12c of the light guide plate 12 to an area near the end edge portion 183b of the optical sheet 183 in the uppermost layer.

More specifically, the light shielding sheet 20 has an adhesive layer on its surface. The light shielding sheet 20 closer to the light incident surface 12c of the light guide plate 12 is bonded and fixed to an area from an end face of the second side wall 16Mc (see FIG. 1B) closer to the light incident surface 12c of the light guide plate 12 to an upper surface of a wiring substrate 132, an upper surface of the optical sheet 181 in the lowermost layer, the end edge portion 182a of the optical sheet 182 in the middle layer, and a point near the end edge portion 183e of the optical sheet 183 in the uppermost layer. Similarly, the light shielding sheet 20 closer to the end face 12e opposed to the light incident surface 12c of the light guide plate 12 is bonded and fixed to an area from an end face of the second side wall 16Mc (see FIG. 1B) closer to the end face 12e opposed to the light incident surface 12c of the light guide plate 12 to an upper surface of the resin portion 16Rb of the frame 16 and a point near the end edge portion 183b of the optical sheet 183 in the uppermost layer.

The wiring substrate 132 of the light source 14 is fixed to an upper surface of the resin portion 16Ra of the frame 16 with double-sided tape 130.

As illustrated in FIGS. 4A and 4B as an applied example of disposition of the light shielding sheet 20, the light shielding sheet 20 may be disposed also along the first side wall 16Mb of the frame 16. In this case, as illustrated in FIGS. 4A and 4B, the light shielding sheet 20 is preferably formed to integrally include at least a portion 20b that covers an end face of the first side wall 16Mb and a portion 20a that covers an outer side surface of the first side wall 16Mb.

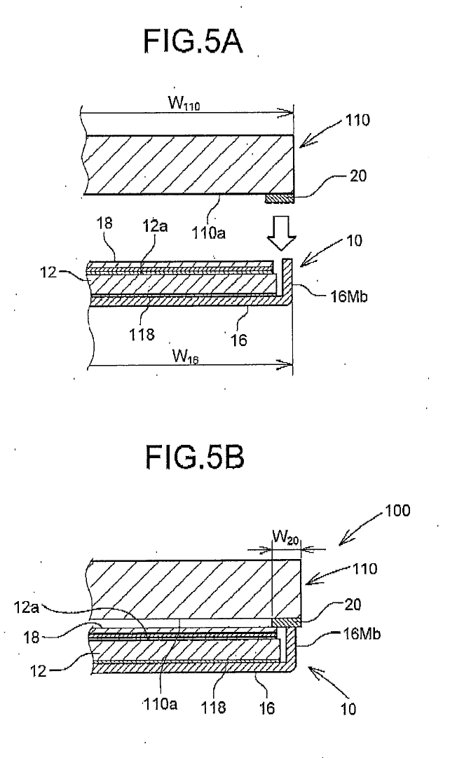

A widely used type of the light shielding sheet 20 commonly has adhesive layers on a first surface 201 that faces the LCD 110 (to be described later with reference to FIGS. 5A and 5B) and a second surface 202 that faces the light guide plate 12, suggesting an appearance of double-sided tape. However, in the example illustrated in FIG. 4A, the adhesive layer is applied to the surface of the light shielding sheet 20 excluding at least the outer side surface of the portion 20a disposed on the outer side surface of the first side wall 16Mb. Specifically, the adhesive layer is applied to portions other than the first surface 201 of the portion 20a disposed on the outer side surface of the first side wall 16Mb (in FIG. 4A, the right side surface of the portion 20a); specifically, the adhesive layer is applied to the second surface 202 of the portion 20a (in FIG. 4A, the left side surface of the portion 20a), and the first surface 201 and the second surface 202 of the portion 20b (in FIG. 4A, the upper surface and the lower surface of the portion 20b) that covers the end face of the first side wall 16Mb. These adhesive layers result in the light shielding sheet 20 being bonded and fixed to the first side wall 16Mb and the optical sheet 183. It is again noted that at least the outer side surface (the first surface 201) of the portion 20a disposed on the outer side surface of the first side wall 16Mb has no adhesive layer. This arrangement prevents the outer side surface (the first surface 201) of the portion disposed on the outer side surface of the first side wall of the light shielding sheet 20 from impairing handling of the planar illumination device 10 when the light shielding sheet 20 is fixed to the outer side surface of the first side wall 16Mb, because the outer side surface (the first surface 201) of the portion disposed on the outer side surface of the first side wall of the light shielding sheet 20 has no adhesiveness that impedes handling (carrying) of the planar illumination device 10. In FIG. 4A, reference numeral 20se denotes a separator.

In contrast, the light shielding sheet 20 according to an example illustrated in FIG. 4B has an adhesive layer also on the outer side surface (the first surface 201) of the portion 20a disposed on the outer side surface of the first side wall 16Mb; however, this adhesive layer is covered with a film 30. Thus, this arrangement does not impair handling as in the example illustrated in FIG. 4A.

As illustrated in FIGS. 5A and 5B, to configure the liquid crystal display apparatus 100 by disposing the LCD 110 closer to the light emitting surface 12a of the light guide plate 12 of the planar illumination device 10 according to the embodiment of the present invention, the following steps may be followed. Specifically, as illustrated in FIG. 5A, the light shielding sheet 20 is affixed to a portion of a surface 110a of the LCD 110 facing the planar illumination device 10, the portion being opposed to an end face of the first side wall 16Mb in the frame 16 of the planar illumination device 10. Then, as illustrated in FIG. 5B, the LCD 110 and the planar illumination device 10 are fixed to each other with the light shielding sheet 20.

In this case, preferably, a width W₁₆ between the first side walls 16Mb (see PIG. 1B) is set to be smaller than a corresponding width W₁₁₀ of the LCD 110. Thereby, preferably, the light shielding sheet 20 is affixed to the portion of the surface 110a in the LCD 110 facing the planar illumination device 10, the portion being opposed to the end face of each of the first side walls 16Mb, so as to cover a range from an outside of the outer surface of the first side wall 16Mb up to an outer edge portion of the effective area of the light emitting surface 12a of the light guide plate 12 (indicated in FIG. 5B by a width W₂₀ of the light shielding sheet 20).

The embodiment of the present invention as configured as described above achieves the following advantageous effects.

Specifically, the embodiment of the present invention includes the bottom portion 16Ma and the resin portions 16Ra and 16Rb that constitute the frame 16 for holding and positioning the elements of the planar illumination device 10 including the light guide plate 12, the light source 14, and the optical sheets 18. The bottom portion 16Ma, formed of sheet metal, can provide necessary strength for the frame 16. The resin portions 16Ra and 16Rb are disposed so as to be opposed to the light incident surface 12c of the light guide plate 12 and the end face 12e opposite to the light incident surface 12c, respectively. When the light guide plate 12 is assembled to the frame 16, therefore, the light guide plate 12 is positioned while being brought into contact with the resin portions 16Ra and 16Rb, so that likelihood of production of contaminants can be reduced. Additionally, as illustrated in FIG. 1C, no resin portions 16Ra and 16Rb are disposed along the two facing sides each connecting the end of the side of the frame 16 closer to the light incident surface 12c of the light guide plate 12 and the end of the side of the frame 16 farther from the light incident surface 12c. This arrangement allows the thickness of the frame 16 in each of the two facing sides to be equal to the thickness of the first side wall 16Mb (e.g., 0.1 mm to 0.2 mm), achieving a narrower framework of the planar illumination device 10.

The resin portions 16Ra and 16Rb can provide proper insulation between the bottom portion 16Ma as a metal portion and the wiring substrate 132 of the light source 14. Furthermore, when the planar illumination device 10 is used in combination with the LCD 110 (see FIGS. 5A and 5B), the resin portions 16Ra and 16Rb allow a larger fixing area for the LCD 110. In addition, light that leaks from the end face 12e opposite to the light incident surface 12c of the light guide plate 12 in particular is reflected to the light guide plate 12 by the resin portion 16Rb that faces the end face 12e. This reflection contributes to enhanced efficiency of light emitting from the principal surface 12a of the light guide plate 12.

As illustrated in FIG. 1C, the first side wall 16Mb extends upward continuously from the bottom portion 16Ma of the frame 16 along each of the two facing sides of the bottom portion 16Ma, each of the sides connecting the end of the side of the bottom portion 16Ma closer to the light incident surface 12c of the light guide plate 12 and the end of the side of the bottom portion 16Ma farther from the light incident surface 12c. Thereby, light that leaks from the end faces of the light guide plate 12 corresponding to the two facing sides is reflected by the first side walls 16Mb to the light guide plate 12, which contributes to enhanced efficiency of light emitting from the principal surface 12a of the light guide plate 12. Additionally, the first side walls 16Mb contribute to an even more improved strength of the frame 16.

The second side walls 16Mc supplement strength of the resin portions 16Ra and 16Rb, to thereby further improve the strength of the frame 16. The second side walls 16Mc may be disposed so as to cover the outer side surfaces of the resin portions 16Ra and 16Rb or to fit between the outer and inner side surfaces of the resin portions 16Ra and 16Rb. In either case, the resin portions 16Ra and 16Rb are positioned while being in contact with the light guide plate 12 when the light guide plate 12 is assembled to the frame 16, which reduces the likelihood of production of contaminants. The resin portion 16Ra can provide proper insulation between the second side wall 16Mc as a metal and the wiring substrate 132 of the light source 14.

The resin portion 16Ra and the bottom portion 16Ma (and the second side wall 16Mc) of the frame 16 are integrated with each other by insert molding to thereby form a frame combining a metal and a resin, thus achieving the abovementioned advantageous effects.

Although not illustrated, an arrangement that excludes either one or both of the first side walls 16Mb and the second side walls 16Mc allows removal of the metal frame portion, and further reduction in weight of the frame 16. Whether to include the first side walls 16Mb and the second side walls 16Mc is desirably examined in consideration of the balance between strength and weight.

As illustrated in FIG. 2, the first protrusions 16F that protrude from the resin portion 16Ra toward the light incident surface 12c of the light guide plate 12 abut against the light incident surface 12c of the light guide plate 12 to thereby form the space S in which the light source 14 (see FIG. 1B) can be disposed between the resin portion 16Ra and the light guide plate 12, while allowing the resin portion 16Ra and the light guide plate 12 to be positioned correctly. The first protrusions 16F are formed at positions to circumvent the light source 14 and to allow the resin portion 16Ra and the light guide plate 12 to be positioned. For example, in a plan view of the light guide plate 12, the first protrusions 16F may be disposed on both ends of the light incident surface 12c as illustrated in FIG. 2, or disposed at appropriate positions on both ends and in the middle of the light incident surface 12c so as to be opposed to the light incident surface 12c.

Additionally, as illustrated in FIG. 2, the second protrusion 12F that protrudes from the light incident surface 12c of the light guide plate 12 toward the resin portion 16Ra of the frame 16 disposed to face the light incident surface 12c abuts against the resin portion 16Ra to thereby form the space S in which the light source 14 can be disposed between the resin portion 16Ra and the light guide plate 12, while allowing the resin portion 16Ra and the light guide plate 12 to be positioned correctly. Thus, the second protrusion 12F is formed at a position to circumvent the light source 14 and to allow the resin portion 16Ra and the light guide plate 12 to be positioned. For example, in a plan view of the light guide plate 12, the second protrusion 12F is disposed at an appropriate position including one end, both ends, and in the middle of the light incident surface 12c. Additionally, as illustrated in FIG. 2, the first protrusions 16F and the second protrusion 12F may be used in combination with each other, and the first protrusions 16F and the second protrusion 12F may be disposed so as not to face each other. Alternatively, as illustrated at left in FIG. 2, the first protrusion 16F is disposed so as to face the second protrusion 12F and abut against each other.

As illustrated in FIGS. 4A and 4B, the effective area of the light emitting surface 12a of the light guide plate 12 can be defined by the light shielding sheet 20 disposed to extend along the first side walls 16Mb of the frame 16. The light shielding sheet 20 is integrally formed to cover at least the end face and the outer side surface of each first side wall 16Mb. The light shielding sheet 20 is positioned with respect to the first side wall 16Mb with a necessary contact area left on the outer side surface of the first side wall 16Mb. Moreover, the portion 20b that is formed integrally with the portion 20a covering the outer side surface of the first side wall 16Mb and that covers the end face of the first side wall 16Mb can prevent light from leaking to the outside of the planar illumination device 10 from a clearance along the first side wall 16Mb between the light guide plate 12 and the first side wall 16Mb, and between the optical sheets 18 disposed on the light emitting surface 12a and the first frame, and can prevent entry of foreign matter including contaminants into the inside. Additionally, extending the portion 20b that covers the end face of the first side wall 16Mb up to, and fixing the portion 20b to, the optical sheets 18 disposed on the light emitting surface 12a of the light guide plate 12 will fix the portion 20b to the optical sheet 183 and, at the same time, define the effective area of the light guide plate along the first side wall 16Mb.

As illustrated in FIG. 5B, what is called a backlight liquid crystal display apparatus 100 is configured in which the planar illumination device 10 illuminates the LCD 110 stacked on the side of the light emitting surface 12a of the light guide plate 12 of the planar illumination device 10.

The light shielding sheet 20 has adhesive layers on both the first surface 201 that faces the LCD 110 and the second surface 202 that faces the light guide plate 12, so that the LCD 110 and the planar illumination device 10 are fixed to each other via the light shielding sheet 20. The first surface 201 of the light shielding sheet 20 is affixed to the portion of the surface 110a of the LCD 110 facing the planar illumination device 10, the portion being opposed to the end face of the first side wall 16Mb, before the LCD 110 is stacked on the planar illumination device 10 (see FIG. 5A). This affixation reliably positions the light shielding sheet 20 with respect to the flat LCD 110. In this state, the LCD 110 is stacked on the planar illumination device 10 (see FIG. 5B). As a result, the light shielding sheet 20 is less likely to be displaced due to bonding failure and good workability can be achieved during assembly.

In addition, the width W₁₆ between the first side walls 16Mb that extend upward continuously from the bottom portion 16Ma is smaller than the corresponding width W₁₁₀ of the LCD 110. This arrangement enlarges the range over which the light shielding sheet 20 can be affixed to the LCD 110 and accordingly increases the width W₂₀ of the light shielding sheet 20. Specifically, the light shielding sheet 20 is affixed to the portion of the surface 110a in the LCD 110 facing the planar illumination device 10, the portion being opposed to the end face of each of the first side walls 16Mb, so as to cover a range from the outside of the outer surface of the first side wall 16Mb up to the outer edge portion of the effective area of the light emitting surface 12a of the light guide plate 12. The increase in the width W₂₀ of the light shielding sheet 20 leads to good workability during assembly of the liquid crystal display apparatus 100. In addition, the increase improves ease of handling of the light shielding sheet 20 and adhesive strength of the light shielding sheet 20.

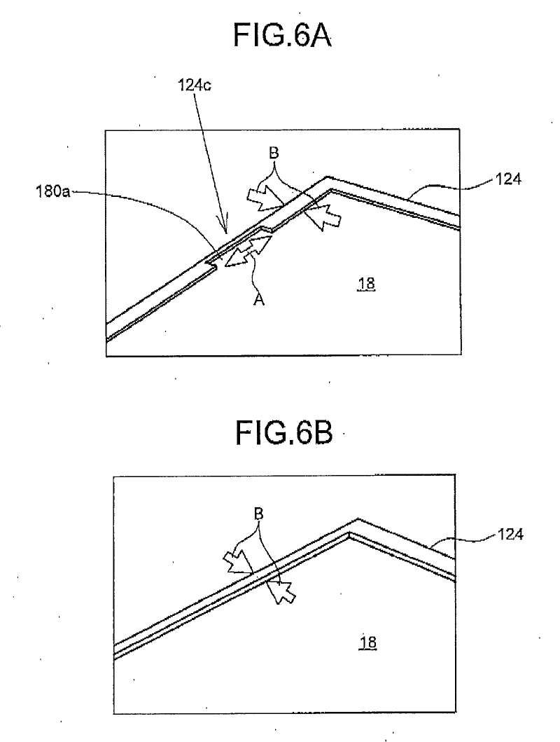

To mention briefly, the procedure to assemble the liquid crystal display apparatus 100 described with reference to FIGS. 5A and 5B is applicable to a configuration other than the planar illumination device 10 having the configurations according to the embodiment. It is understandable that the same advantageous effects can be achieved in the application of the assembly procedure to, for example, planar illumination devices that include the related-art closed-bottom framework-shaped resin frame 124 (see FIGS. 6A and 6B) or only a sheet-metal frame.

According to the embodiment, it is possible to promote further reduction in the width of the framework, while achieving necessary strength of the planar illumination device.

A liquid crystal display apparatus may include: a planar illumination device including: a light guide plate having a pair of principal surfaces opposed to each other, one of the principal surfaces serving as a light emitting surface; a light source disposed to face a light incident surface of the light guide plate; an optical sheet disposed on the light emitting surface of the light guide plate; a light shielding sheet that defines an effective area of the light emitting surface of the light guide plate; and a frame that houses therein the foregoing elements of the planar illumination device; and a liquid crystal panel stacked on the side of the light emitting surface of the light guide plate, wherein the light shielding sheet has adhesive layers formed on-both a first surface that faces the liquid crystal panel and a second surface that faces the light guide plate and, before the liquid crystal panel is stacked on the planar illumination device, the first surface of the light shielding sheet is affixed to a portion of a surface of the liquid crystal panel facing the planar illumination device, the portion being opposed to an end face of the first side wall of the frame of the planar illumination device.

A method of assembling a liquid crystal display apparatus may include: providing a liquid crystal display apparatus, comprising: a planar illumination device that includes: a light guide plate having a pair of principal surfaces opposed to each other, one of the principal surfaces serving as a light emitting surface; a light source disposed to face a light incident surface of the light guide plate; an optical sheet disposed on the light emitting surface of the light guide plate; a light shielding sheet that defines an effective area of the light emitting surface of the light guide plate; and a frame that houses therein the foregoing elements of the planar illumination device; and a liquid crystal panel stacked on the side of the light emitting surface of the light guide plate; affixing the light shielding sheet to a portion of a surface of the liquid crystal panel facing the planar illumination device, the portion being opposed to an end face of the first side wall of the frame of the planar illumination device; and fixing the liquid crystal panel and the planar illumination device with the light shielding sheet.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A planar illumination device, comprising:
a light guide plate including a pair of principal surfaces opposed to each other, one of the principal surfaces serving as a light emitting surface;
a light source disposed to face a light incident surface of the light guide plate;
an optical sheet disposed on the light emitting surface of the light guide plate; and
a frame that houses therein the light guide plate, wherein
the frame includes a bottom portion formed of a sheet metal and a pair of resin portions facing the light incident surface of the light guide plate and an end face of the light guide plate opposite to the light incident surface, respectively.

2. The planar illumination device according to claim 1, wherein the frame includes first side walls that extend upward continuously from the bottom portion of the frame along two facing sides of the bottom portion, each of the sides connecting an end of a side of the bottom portion closer to the light incident surface of the light guide plate and an end of a side of the bottom portion farther from the light incident surface.

3. The planar illumination device according to claim 1, wherein the frame includes second side walls that extend upward continuously from the bottom portion of the frame along a side of the bottom portion closer to the light incident surface of the light guide plate and a side of the bottom portion farther from the light incident surface.

4. The planar illumination device according to claim 1, wherein the resin portions and the bottom portion of the frame are integrated with each other by insert molding.

5. The planar illumination device according to claim 1, wherein the resin portion of the frame facing the light incident surface of the light guide plate includes a first protrusion that protrudes toward the light incident surface of the light guide plate.

6. The planar illumination device according to claim 1, wherein the light incident surface of the light guide plate includes a second protrusion that protrudes toward the resin portion of the frame facing the light incident surface.

7. The planar illumination device according to claim 2, further comprising:
a light shielding sheet configured to define an effective area of the light emitting surface of the light guide plate, wherein
the light shielding sheet is integrally formed along the first side walls of the frame to cover at least end faces and outer side surfaces of the first side walls.

8. The planar illumination device according to claim 7, wherein the light shielding sheet includes adhesive layers formed on surfaces of the light shielding sheet, excluding at least an outer side surface of a portion of the light shielding sheet disposed on the outer side surface of the first side walls.

9. The planar illumination device according to claim 7, wherein the light shielding sheet includes adhesive layers formed on surfaces of the light shielding sheet, and the adhesive layers formed on the outer side surface of the portion disposed on the outer side surfaces of the first side wall are covered with a film.

10. A liquid crystal display apparatus, comprising:
a planar illumination device including:
a light guide plate including a pair of principal surfaces opposed to each other, one of the principal surfaces serving as a light emitting surface;
a light source disposed to face a light incident surface of the light guide plate;
an optical sheet disposed on the light emitting surface of the light guide plate; and
a frame that houses therein the light guide plate, wherein
the frame includes a bottom portion formed of a sheet metal and a resin portion facing the light incident surface of the light guide plate, and
the frame includes first side walls that extend upward continuously from the bottom portion of the frame along two facing sides of the bottom portion, each of the sides connecting an end of a side of the bottom portion closer to the light incident surface of the light guide plate and an end of a side of the bottom portion farther from the light incident surface;
a liquid crystal panel stacked on a side of the light emitting surface of the light guide plate; and
a light shielding sheet configured to define an effective area of the light emitting surface of the light guide plate, wherein
the light shielding sheet includes adhesive layers formed on both a first surface that faces the liquid crystal panel and a second surface that faces the light guide plate, and
the first surface of the light shielding sheet is affixed to a portion of a surface of the liquid crystal panel facing the planar illumination device before the liquid crystal panel is stacked on the planar illumination device, the portion being opposed to end faces of the first side walls of the frame of the planar illumination device.

11. The liquid crystal display apparatus according to claim 10, wherein
a width between the first side walls that extend upward continuously from the bottom portion of the frame of the planar illumination device is smaller than a corresponding width of the liquid crystal panel, and
the light shielding sheet is affixed to the portion of the surface of the liquid crystal panel facing the planar illumination device, the portion being opposed to the end face of each of the first side walls of the frame of the planar illumination device, so as to cover a range from an outside of an outer surface of each of the first side walls up to an outer edge portion of the effective area of the light emitting surface of the light guide plate.

12. A method of assembling a liquid crystal display apparatus, the method comprising:
providing the planar illumination device according to claim 2 and a liquid crystal panel disposed closer to the light emitting surface of the light guide plate;
affixing a light shielding sheet configured to define an effective area of the light emitting surface of the light guide plate to a portion of a surface of the liquid crystal panel facing the planar illumination device, the portion being opposed to end faces of the first side walls of the frame of the planar illumination device; and
fixing the liquid crystal panel and the planar illumination device with the light shielding sheet.

13. The method of assembling the liquid crystal display apparatus according to claim 12, further comprising:
setting a width between the first side walls that extend upward continuously from the bottom portion of the frame of the planar illumination device smaller than a corresponding width of the liquid crystal panel; and
affixing the light shielding sheet to the portion of the surface of the liquid crystal panel facing the planar illumination device, the portion being opposed to the end face of each of the first side walls of the frame of the planar illumination device, so as to cover a range from an outside of an outer surface of each of the first side walls up to an outer edge portion of the effective area of the light emitting surface of the light guide plate.

14. A planar illumination device, comprising:
a light guide plate including a pair of principal surfaces opposed to each other, one of the principal surfaces serving as a light emitting surface;
a light source disposed to face a light incident surface of the light guide plate;
an optical sheet disposed on a side of the light emitting surface of the light guide plate; and
a frame that houses therein the light guide plate wherein
the frame includes a bottom portion formed of a sheet metal and a resin portion that faces the light incident surface of the light guide plate.

15. The planar illumination device according to claim 14, wherein the frame includes first side walls that extend upward continuously from the bottom portion of the frame along two facing sides of the bottom portion, each of the sides connecting an end of a side of the bottom portion closer to the light incident surface of the light guide plate and an end of a side of the bottom portion farther from the light incident surface.

16. The planar illumination device according to claim 14, wherein the frame includes second side walls that extend upward continuously from the bottom portion of the frame along a side of the bottom portion closer to the light incident surface of the light guide plate and a side of the bottom portion farther from the light incident surface.

17. The planar illumination device according to claim 14, wherein the resin portion and the bottom portion of the frame are integrated with each other by insert molding.

18. The planar illumination device according to claim 14, wherein the resin portion of the frame includes a first protrusion that protrudes toward the light incident surface of the light guide plate.

19. The planar illumination device according to claim 14 wherein the light incident surface of the light guide plate includes a second protrusion that protrudes toward the resin portion of the frame.
